(19) United States
(12) Patent Application Publication
(10) Pub. No.: US 2021/0003462 A1
(43) Pub. Date: Jan. 7, 2021

(54) X-RAY STRESS MEASUREMENT DEVICE

(71) Applicant: SHIMADZU CORPORATION, Kyoto-shi (JP)

(72) Inventors: Yasuyuki OKAMOTO, Kyoto-shi (JP); Kazuo KOYANAGI, Kyoto-shi (JP)

(73) Assignee: SHIMADZU CORPORATION, Kyoto-shi (JP)

(21) Appl. No.: 16/459,831

(22) Filed: Jul. 2, 2019

(51) Int. Cl. G01L 1/25; G01N 23/207; G01N 23/223; G01N 23/20008

(52) U.S. Cl. CPC G01L 1/25; G01N 23/207; G01N 2203/0641; G01N 23/20008; G01N 23/223

(57) ABSTRACT

An X-ray generator 110 irradiates with an X-ray beam onto a polycrystalline sample on a sample stage 113. An X-ray detector 116 including an array of X-ray detecting elements detects the intensities of diffracted X-rays which occur from the X-ray beam incident on the sample. A rotary drive rotates the X-ray generator, X-ray detector and sample-holding section so as to maintain a predetermined relationship between the angle formed by the sample surface and the incident X-ray beam, and the angle formed by the sample surface and the diffracted X-ray travelling toward the X-ray detector. A stress measurement section rotates, for a measurement of a stress value of the sample, either the X-ray generator and the X-ray detector or the sample stage so as to change the angle formed by the sample surface and the incident X-ray beam, while maintaining the positional relationship of the X-ray generator and the X-ray detector.

### TECHNICAL FIELD

The present invention relates to an X-ray stress measurement device configured to measure the stress in a piece metal or similar sample using an X-ray diffraction phenomenon.

### BACKGROUND ART

As a method for measuring the residual stress in a sample made of a polycrystal, a method has been known which uses the phenomenon of X-ray diffraction that occurs when an X-ray beam is irradiated onto the sample (Non-Patent Literature 1). This method is hereinafter called the “X-ray stress measuring method”. The measurement principle of this method is hereinafter described with reference to FIG. 1. Polycrystal is a substance composed of a considerable number of crystal grains (single crystals). However, for convenience of explanation, FIG. 1 only shows one crystal grain which is present in a surface region of the sample, having the lattice planes orthogonal to a plane of paper. It should also be noted that FIG. 1 shows a situation in which the measurement is being performed to determine the distortion of the sample in the direction of the normal OP to the lattice planes of the crystal grain in the Z-O-X plane formed by the normal direction to the sample surface and the direction of the stress to be measured. In FIG. 1, ψ represents the angle formed by a normal (OZ) to the sample surface and a normal OP to the lattice planes, θ represents the angle formed by an incident X-ray beam and the lattice planes, and ψ₀ represents the angle formed by the normal to the sample surface and the incident X-ray beam (this angle is hereinafter called the “incident angle”). The character η represents the angle formed by the normal OP to the lattice planes and the incident X-ray beam, as well as the angle formed by the normal OP to the lattice planes and a diffracted X-ray. This angle η corresponds to the incident angle of the X-ray to the lattice planes of the crystal grain concerned. The angle formed by the extension of the incident X-ray beam and the diffracted X-ray is equal to 2θ.

Consider the case where an X-ray beam of wavelength λ is incident on a crystal grain whose lattice planes are parallel to the sample surface (i.e. ψ=0°). The maximum intensity of the diffracted X-ray occurs when the angle θ formed by the incident X-ray beam and the lattice planes satisfies the Bragg's equation: 2d sin θ=nλ, where d is the distance between the lattice planes and n is an integer. Accordingly, by measuring the intensity of the diffracted X-ray exiting from the sample surface in a direction at angle 2θ from the extension of the incident X-ray beam while gradually changing the angle θ of the X-ray beam irradiated onto the sample, a diffracted X-ray intensity distribution curve which shows the relationship between the angle 2θ and the intensity of the diffracted X-ray can be obtained as shown in FIG. 2A. The angle 2θ₀ (or θ₀) at which the maximum intensity occurs in this diffracted X-ray intensity distribution curve is the angle which satisfies the Bragg's equation. The angle 2θ₀ in this situation is called the diffraction angle (or more specifically, the diffraction angle at ψ=0°).

The previously described phenomenon similarly occurs in the case where an X-ray beam is incident on a crystal grain whose lattice planes are inclined to the sample surface by angle ψ as shown in FIG. 1. In this case, a diffracted X-ray intensity distribution curve similar to FIG. 2A can be obtained by obliquely irradiating with the X-ray beam onto the sample at angle ψ to the direction corresponding to ψ=0°. The angle 2θ at which the maximum intensity occurs in the diffracted X-ray intensity distribution curve varies for each different angle ψ. There are a considerable number of crystal grains within the area hit by the X-ray beam, and those crystal grains vary in the orientation of their lattice planes. Therefore, the diffraction angle, i.e. the angle 2θ at which the maximum intensity occurs, can be obtained for each different angle ψ by determining the diffracted X-ray intensity distribution curve while gradually changing the angle ψ. The diffraction angle at angle ψ is hereinafter represented by 2θ_{ψ}.

The diffraction angle 2θ_{ψ} depends on the distance d between the lattice planes of the crystal grain. The larger the distance d between the lattice planes is, the smaller the diffraction angle 2θ_{ψ} is. If the sample is subjected to a tensile stress, a crystal grain having a larger value of angle ψ shows a greater increase in the distanced between the lattice planes. The larger the tensile stress is, the larger the increase in the distance d is. Based on this fact, in the X-ray stress measurement, the diffraction angle 2θ_{ψ} is determined for each different angle ψ, and the residual stress in the sample is estimated from the measured result. Specifically, the diffraction angle 2θ_{ψ} determined for each different angle ψ is plotted on a 2θ-sin²ψ diagram (see FIG. 2B) which shows the relationship between the diffraction angle 2θ_{ψ} and sin²ψ. An equation expressing a straight line that connects the plotted points is determined by the least squares method. The amount of stress is calculated from a coefficient of the equation (i.e. from the gradient of the straight line). For example, if the equation expressing the straight line is Y=A+M*X, the stress value σ is given by the following equation:

σ=K*M (1)

where K represents the stress constant.

In a conventional X-ray stress measuring method, a device as shown in FIG. 3 (X-ray stress measurement device) is used to irradiate with an X-ray beam onto the sample, measure the intensity of the diffracted X-ray occurring from the incident X-ray beam, and determine the diffracted X-ray intensity distribution curve from the measured result. In the X-ray stress measurement device, an X-ray tube 10 and a beam-irradiating slit 11 are fixed to an outer circumferential portion of a goniometer 17, while sample S is placed so that its surface contains the center of the goniometer 17. An X-ray beam emitted from the X-ray tube 10 passes through the beam-irradiating slit 11 and hits sample S placed on a sample holder 13. The X-ray diffracted by sample S passes through an exit slit 15 and enters an X-ray detector 16. A scintillation counter or a proportional counter filled with gas is normally used as the X-ray detector 16. The X-ray detector 16 produces a detection signal corresponding to the intensity of the X-ray which has entered the detector.

In order to detect the diffracted X-ray with the X-ray detector 16, it is necessary to continuously change the angle θ over a predetermined angular range while constantly maintaining the relationship in which the angle θ formed by the incident X-ray beam and the surface of sample S (lattice plane) is equal to the angle θ formed by the surface of sample S and the X-ray travelling from sample S toward the X-ray detector 16. To this end, the goniometer 17 includes a driving shaft for rotating the holding portion of the sample holder 13 (the inner circumferential portion of the goniometer 17) and another driving shaft for rotating the X-ray detector 16 and the exit slit 15. These driving shafts are coaxial with each other and configured to be simultaneously rotated by a ratio of θ:2θ, or 1:2.

In the conventional device, the sample holder 13 and the X-ray detector 16 are mechanically driven by means of the goniometer 17 to gradually change the angle θ of the X-ray for each different angle ψ to measure the intensity of the diffracted X-ray, and the diffraction angle is subsequently determined based on the measured result. Such a method requires a considerable amount of time to determine the value of the stress acting on sample S.

A conventional stress-measuring method aimed at addressing such a problem employs a position sensitive detector (PSD) as the detector for the diffracted X-ray. The PSD can simultaneously measure X-ray intensities within a certain range of diffraction angles and thereby eliminates the necessity to gradually change the angle θ. This shortens the period of time required for the stress measurement (Patent Literature 1).

The conventional method employing the PSD has the following problem.

Samples to be analyzed by an X-ray stress measuring method significantly vary in the kind of material. For example, it is commonly known that a peak which appears in the diffracted X-ray intensity distribution curve for a sample made of an iron-based material has a large half-value width if there is a high amount of residual stress in the sample. A specific example is alpha iron. If a Cr-Kα radiation, which is a characteristic X-ray of alpha iron, is irradiated onto the (211) plane of alpha iron, the half-value width of the peak appearing in the diffracted X-ray intensity distribution curve (with an approximately peak position 2θ of 156 degrees) can be as large as 8 to 9 degrees. On the other hand, the measurement angular range of the PSD is not larger than approximately 18 degrees (if the goniometer has a radius of 200 mm). A peak which appears in the diffracted X-ray intensity distribution curve for alpha iron or similar samples cannot be completely included within the measurement angular range of the PSD (see FIG. 4).

### CITATION LIST

### Patent Literature

Patent Literature 1: JP 2001-324392 A

### Non-Patent Literature

Non-Patent Literature 1: “Standard for X-Ray Stress Measurement (2002)=Iron and Steel=(JSMS-SD-5-02)”, published by The Society of Materials Science, Japan, and planned by JSMS Committee on X-ray Study of Mechanical Behavior of Materials

### SUMMARY OF INVENTION

### Technical Problem

A typical process for determining the position at which the maximum intensity occurs (i.e. the peak-top position) in a diffracted X-ray intensity distribution curve is as follows: A measurement is performed over a wide range which additionally includes background sections on both sides of the peak waveform. After the two end points of the peak waveform have been determined, and a line segment connecting those two points is defined as the base line. Then, a subtracting operation for removing the base line from the peak waveform is performed, and the remaining waveform is normalized. In such a case, the measurement angular range of the PSD mentioned earlier is too narrow to perform the measurement of the X-ray intensity over a wide range which extends beyond both end points of the peak waveform. Therefore, for convenience, a line segment which connects the two end points of the peak waveform within the measurement angular range is assumed to be the base line which is used in the subtracting operation to determine the peak-top position.

As with the curve “A” shown in FIG. 4, if the peak-top position is located roughly at the center of the measurement angular range of the PSD, the gradient of the line segment assumed to be the base line in the previously described method (indicated by the dashed line) will not be significantly different from that of the true base line. By comparison, if the peak-top position is significantly displaced from the center of the measurement angular range of the PSD, the gradient of the line segment assumed to be the base line will be significantly different from that of the true base line. Consequently, the peak-top position determined from the peak waveform from which the base line has been removed will be displaced from the true position. The displacement of the peak-top position leads to a change in the gradient of the straight line in the 2θ-sin²ψ diagram, which means that the stress value cannot be correctly determined.

The problem to be solved by the present invention is to shorten the period of time required for the measurement of the stress value of a sample, as well as to correctly determine the stress value of the sample regardless of the kind of material of the sample subjected to the X-ray stress measurement.

### Solution to Problem

The present invention developed for solving the previously described problem is an X-ray stress measurement device configured to measure a stress in a sample made of a polycrystal by utilizing a diffraction phenomenon which occurs when an X-ray beam is irradiated onto the sample, the device including:

a sample-holding section;

an X-ray irradiating section configured to irradiate with an X-ray beam onto a sample held in the sample-holding section;

an X-ray detector section including a plurality of X-ray detecting elements one-dimensionally arrayed in a predetermined direction, the X-ray detector section configured to detect the intensities of diffracted X-rays which are a radiation of X-rays diffracted from the sample within a predetermined angular range when the X-ray beam is irradiated from the X-ray irradiating section onto the sample;

a rotary drive section configured to individually rotate the X-ray irradiating section, the X-ray detector section and the sample-holding section so as to maintain a predetermined relationship between the angle formed by the surface of the sample held in the sample-holding section and the X-ray beam incident on the surface of the sample, and the angle formed by the surface of the sample and the diffracted X-ray travelling from the sample toward the X-ray detector section; and

a stress measurement section configured to rotate, for a measurement of a stress value of the sample, either the X-ray irradiating section and the X-ray detector section or the sample-holding section so as to change the angle formed by the surface of the sample held in the sample-holding section and the X-ray beam incident on the surface of the sample, while maintaining the positional relationship of the X-ray irradiating section and the X-ray detector section.

In the present invention, the X-ray detector section includes a considerable number of X-ray detecting elements one-dimensionally arrayed in a predetermined direction. Therefore, the detector section can simultaneously detect the intensities of the X-rays diffracted from crystal grains in a sample within a predetermined angular range when an X-ray beam is incident on the sample. Therefore, it is necessary to only rotate either the X-ray irradiating section and the X-ray detector section, or the sample-holding section, to measure the stress value of the sample. Accordingly, the time required for the stress measurement can be shortened.

In a preferable mode of the present invention, the stress measurement section includes:

a first measurement section configured to arrange the sample-holding section, the X-ray irradiating section and the X-ray detector section so that the angle formed by the surface of the sample held in the sample-holding section and an incident X-ray beam which is a beam of X-rays incident on the sample becomes equal to θ₀ which satisfies the Bragg's equation, and so that an X-ray included in the radiation of X-rays from the sample and forming an angle of 2θ₀ with an extension of the incident X-ray beam hits an X-ray detecting element located at the center of the X-ray detector section when the sample is in a stress-free state, as well as to make the X-ray irradiating section irradiate with an X-ray beam onto the sample, and to determine a temporary diffraction angle 2θ_{ψ0} from detection values obtained for the X-ray beam by the plurality of X-ray detecting elements of the X-ray detector section:

a second measurement section configured to rotate either the X-ray irradiating section and the X-ray detector section or the sample-holding section, or both, so that the angle formed by the incident X-ray beam and the surface of the sample becomes equal to θ₀+ψₙ, while maintaining the positional relationship of the X-ray irradiating section and the X-ray detector section arranged by the first measurement section when determining the temporary, diffraction angle 2θ_{ψ0}, as well as to make the X-ray irradiating section irradiate with an X-ray beam onto the sample, and to determine a temporary diffraction angle 2θ_{ψn} from detection values obtained by the plurality of X-ray detecting elements of the X-ray detector section for the X-ray beam;

a diffraction angle calculator section configured to create a temporary 2θ-sin²ψ diagram from the combination of the temporary diffraction angle 2θ_{ψ0} and an angle of 0° as well as the combination of the temporary diffraction angle 2θ_{ψn} and an angle of θ₀+ψₙ, and to determine temporary diffraction angles 2θ_{ψ1} to 2θ_{ψn-1} at angles ψ₁ to ψₙ₋₁ within an angular range of 0° to 2θ_{ψn} in the temporary 2θ-sin²ψ diagram, respectively; and

a stress calculator section configured (1) to gradually rotate either the X-ray irradiating section and the X-ray detector section or the sample-holding section, or both, so that the angle formed by the incident X-ray beam and the surface of the sample becomes equal to each of the values from θ₀+ψ₁ to θ₀+ψₙ₋₁, while maintaining the positional relationship of the X-ray irradiating section and the X-ray detector section arranged by the first measurement section when determining the temporary diffraction angle 2θ_{ψ0}, and to make the X-ray irradiating section irradiate with an X-ray beam onto the sample, and to determine a peak-top position from detection values obtained by the plurality of X-ray detecting elements of the X-ray detector section for the X-ray beam, as well as (2) to create a true 2θ-sin²ψ diagram using the determined peak-top positions as true diffraction angles 2θ_{ψ1} to 2θ_{ψn-1} at angles ψ₁ to ψₙ₋₁, and to determine the stress value of the sample from the true 2θ-sin²ψ diagram.

In the present invention, it is preferable to select an angle of 50° as angle ψₙ in order to check the linearity of the 2θ-sin²ψ diagram. In that case, an appropriate number of angles will be selected as the angles ψ₁ to ψₙ₋₁ within the range of 0° to 50°. The angles to be set as angles ψ₁ to ψₙ₋₁ may preferably be, but are not limited to, a plurality of angles obtained by equally dividing the angular range of ψ₁ to ψₙ₋₁.

In the previously described configuration, the first and second measurement sections determine, as the temporary diffraction angles, a diffraction angle 2θ_{ψ0} at a crystal grain whose angle ψ is equal to 0° (=ψ₀) in the sample held in the sample-holding section, i.e. a crystal grain whose lattice planes are parallel to the surface of the sample, as well as a diffraction angle 2θ_{ψn} at a crystal grain whose lattice planes are inclined to the surface of the sample by angle ψₙ, under the condition that an X-ray beam which satisfies the Bragg's equation is incident on the lattice plane. The diffraction angle calculator section creates a 2θ-sin²ψ diagram from those temporary diffraction angles, and determines, from this diagram, temporary diffraction angles 2θ_{ψ1} to 2θ_{ψn-1} at angles ψ₁ to ψₙ₋₁ within the angular range of 0° to ψₙ, respectively.

Subsequently, the stress calculator section gradually rotates either the X-ray irradiating section and the X-ray detector section or the sample-holding section, or both, so that the angle formed by the incident X-ray beam and the surface of the sample becomes equal to each of the values from θ₀+ψ₁ to θ₀+ψₙ₋₁, while maintaining the positional relationship of the X-ray irradiating section and the X-ray detector section arranged by the first measurement section when determining the temporary diffraction angle 2θ_{ψ0}. At each of the rotational positions, the stress calculator section makes the X-ray irradiating section irradiate with an X-ray beam onto the sample, and determines a peak-top position from detection values obtained by the plurality of X-ray detecting elements of the X-ray detector section for the X-ray beam. Since the temporary diffraction angles 2θ_{ψ1} to 2θ_{ψn-1} at angles ψ₁ to ψₙ₋₁ are previously determined, the peak-top position will be located roughly at the center of the measurement angular range of the X-ray detector section, so that a correct peak-top position can be determined in the present invention.

In the present invention, the stress calculator section may be configured to create a graph with a vertical axis indicating the detection values of the plurality of X-ray detecting elements of the X-ray detector section and a horizontal axis indicating the diffraction angles of the diffracted X-rays respectively incident on the X-ray detecting elements, and to determine the peak-top position by performing a profile-fitting operation on the graph. An example of the technique for the profile fitting is the Levenberg-Marquardt method, which is a type of calculation method for the least squares approximation. Examples of the functions for the profile fitting include Gaussian functions, Lorenz functions, and combinations of these types of functions.

In the present invention, the stress calculator section may be configured to create a graph with a vertical axis indicating the detection values of the plurality of X-ray detecting elements of the X-ray detector section and a horizontal axis indicating the angles of the diffracted X-rays respectively incident on the X-ray detecting elements, and to determine the peak-top position by determining a base line in the graph and normalizing the waveform of the graph which remains after a subtracting operation for removing the base line from the graph is performed. As noted earlier, in the present invention, the peak-top position is located roughly at the center of the measurement angular range of the X-ray detector section. Therefore, a correct peak-top position can also be determined by a subtracting operation for removing the base line from the peak waveform.

### Advantageous Effects of Invention

In the X-ray stress measurement device according to the present invention, since a detector including a considerable number of X-ray detecting elements one-dimensionally arrayed in a predetermined direction is used as the X-ray detector section, the device can simultaneously detect the intensities of the X-rays diffracted from crystal grains in a sample within a predetermined angular range when an X-ray beam is incident on the sample. Therefore, for the measurement of the stress value of the sample, it is necessary to only rotate either the X-ray irradiating section and the X-ray detector section or the sample-holding section. Accordingly, the time required for the stress measurement will be shortened. Temporary diffraction angles 2θ_{ψ1}-2θ_{ψn-1} at angles ψ₁ to ψₙ₋₁ are determined, and the arrangement of the X-ray irradiating section and the X-ray detector section is determined based on those temporary diffraction angles. This prevents the peak-top position from being significantly displaced from the center of the measurement angular range of the X-ray detector section. Therefore, a correct peak-top position can be determined regardless of the kind of material of the sample subjected to the X-ray stress measurement, so that the value of the stress acting on the sample can be correctly determined.

### BRIEF DESCRIPTION OF DRAWINGS

FIG. 1 is a diagram illustrating the principle of an X-ray stress measurement.

FIG. 2A is an X-ray diffraction intensity curve.

FIG. 2B is a 2θ-sin²ψ diagram.

FIG. 3 is a schematic configuration diagram of a conventional X-ray stress measurement device.

FIG. 4 is an example of the diffracted X-ray intensity distribution curve obtained with a conventional X-ray stress measurement device.

FIG. 5 is a schematic configuration diagram of an X-ray stress measurement device according to an embodiment of the present invention.

FIG. 6 is a diagram illustrating the principle of an X-ray stress measurement using the X-ray stress measurement device according to the present embodiment.

FIG. 7 is a flowchart of a stress measurement process.

FIG. 8A is an example of the 2θ-sin²ψ diagram created based on the diffraction angles 2θ_{ψ0} and 2θ_{ψn} determined for angles ψ₀ and ψₙ.

FIG. 8B is a diagram showing the relationship between angles ψ₁ to ψₙ₋₁ and temporary diffraction angles 2θ_{ψ1} to 2θ_{ψn-1}, determined from the 2θ-sin²ψ diagram shown in FIG. 8A.

FIG. 9 is an example of the X-ray intensity distribution curve obtained under the condition that the arrangement of the X-ray generator, X-ray detector and sample stage is regulated based on the temporary diffraction angles.

FIG. 10A is a table showing the result of a measurement of the stress value using a conventional device with an X-ray detector having a measurement angular range of 9.02°.

FIG. 10B is a table showing the result of a measurement of the stress value using a conventional device with an X-ray detector having a measurement angular range of 18.33°.

FIG. 11A is a table showing the result of a measurement of the stress value using an X-ray stress measurement device according to the present embodiment with an X-ray detector having a measurement angular range of 9.02°.

FIG. 11B is a table showing a result of the measurement of the stress value using an X-ray stress measurement device according to the present embodiment with the X-ray detector having a measurement angular range of 18.33°.

FIG. 12 is a table showing a summary of the stress values obtained with the conventional device and the X-ray stress measurement device according to the present embodiment.

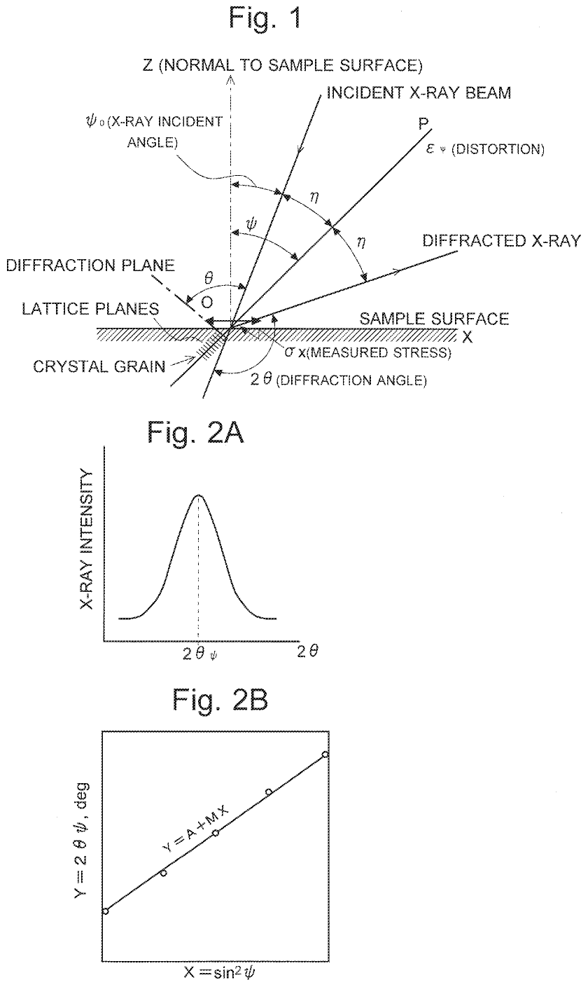

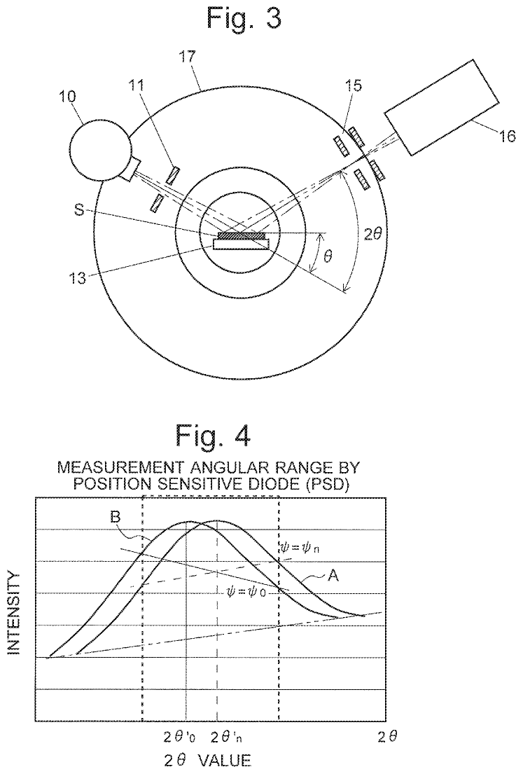

### DESCRIPTION OF EMBODIMENTS

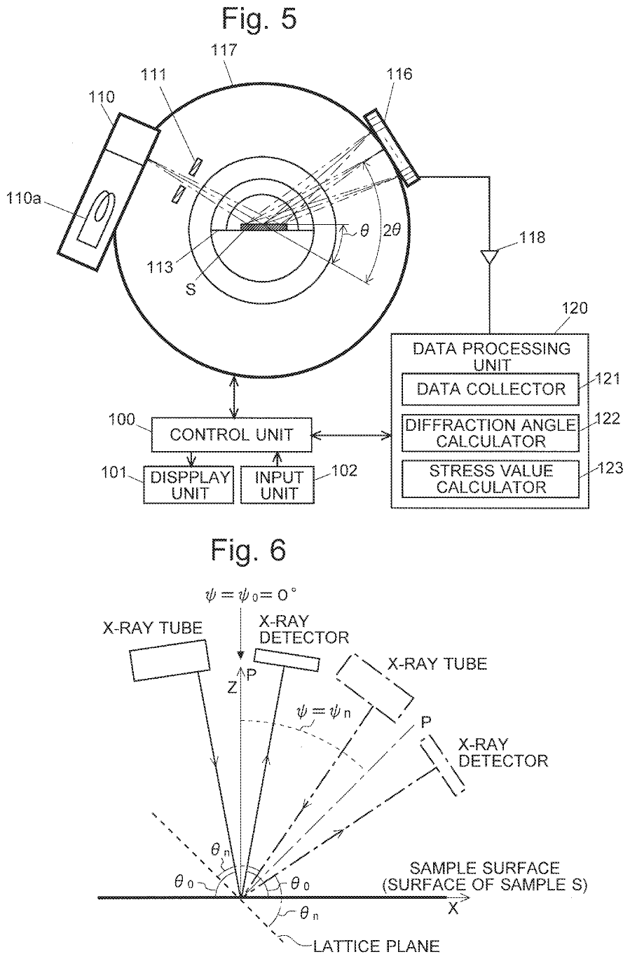

An X-ray stress measurement device according to an embodiment of the present invention is hereinafter described with reference to FIGS. 5 to 12.

FIG. 5 schematically shows the configuration of the X-ray stress measurement device according to the present embodiment. The present X-ray stress measurement device includes a goniometer 117, a sample stage 113 attached to the center of the goniometer 117, as well as an X-ray generator 110, beam-irradiating slit 111 and X-ray detector 116 attached to an outer circumferential portion of the goniometer 117. The X-ray detector 116 includes a considerable number of extremely small X-ray detecting elements arrayed on a straight line. The X-ray generator 110 corresponds to the X-ray irradiating section in the present invention and includes an X-ray tube 110a and generates a specific wavelength of X-rays corresponding to the material of the target.

The goniometer 117 includes a driving shaft for rotating the sample stage 113 and another driving shaft for rotating the X-ray generator 110 and the X-ray detector 116. These driving shafts are coaxial with each other. Using these driving shafts, the goniometer 117 rotates the sample stage 113, X-ray generator 110 and X-ray detector 116 while constantly maintaining the relationship in which the angle θ formed by the surface of sample S and an X-ray beam incident from the X-ray generator 110 onto sample S is equal to the angle θ formed by the surface of sample S and the X-ray travelling from sample S toward an X-ray detecting element located at the center of the X-ray detector 116. To this end, the two driving shafts are rotated at a ratio of θ:2θ. Additionally, the two driving shafts in the present embodiment are also configured to be individually rotatable.

When an X-ray is incident on an X-ray detecting element of the X-ray detector 116, the X-ray detector 116 generates a detection signal corresponding to the intensity of the X-ray. The detection signal obtained with the X-ray detector 116 is sent through an amplifier 118 to a data processing unit 120. The data processing unit 120 includes a data collector 121, diffraction angle calculator 112, stress value calculator 123 and other related components. The data collector 121 corresponds to the first and second measurement sections of the present invention. A control unit 100 is configured to control the operation of each component of the X-ray stress measurement device. Graphs and other results obtained by the signal processing in the data processing unit 120 are sent to the control unit 100 and shown on a display unit 101. Other than the display unit 101, the control unit 100 also includes an input unit 102 for allowing an operator to perform the device setting or command input. The control unit 100 and the data processing unit 120 can be configured using a personal computer as a hardware resource, with the aforementioned functional blocks realized by executing dedicated controlling-and-processing software previously installed on the same personal computer.

Next, a stress measurement operation for sample S made of a polycrystal using the present X-ray stress measurement device is hereinafter described with reference to FIGS. 6 to 9. The following description deals with the case where the position of the X-ray generator 110 and the X-ray detector 116 is changed around sample S held on the sample stage 113 while the sample stage 113 is held in a fixed position. Alternatively, the inclination of the surface of sample S may be changed while the X-ray generator 110 and the X-ray detector 116 are held in a fixed position. It is also possible to change both the rotational position of the X-ray generator 110 and the X-ray detector 116, and the inclination of the surface of sample S. What is essential is to maintain a predetermined positional relationship of the sample stage 113, X-ray generator 110 and X-ray detector 116. In the following description, it is assumed that the XY plane is located on the surface of sample S. The Z axis represents a normal to the surface of sample S.

Before the execution of the stress measurement operation for sample S, a person in charge of the measurement (who is hereinafter called the “operator”) sets the sample stage 113 in the position shown in FIG. 5, and rotates one of the driving shafts of the goniometer 117 to arrange the X-ray generator 110 and the X-ray detector 116 so that the angle formed by the surface of sample S and the incident X-ray beam becomes equal to θ, and so that the angle formed by the surface of sample S and the diffracted X-ray travelling from the surface of sample S to an X-ray detecting element located at the center of the X-ray detector 116 also becomes equal to θ. The position of the X-ray generator 110 and the X-ray detector 116 in this situation is hereinafter called the “initial position”. The angle θ is an angle at which an X-ray beam of wavelength λ hitting the crystal grains forming sample S in a stress-free state satisfies the Bragg's equation. This angle is specific to the material of sample S. Accordingly, an X-ray beam hitting a crystal grain which is present in a surface region of sample S in a stress-free state satisfies the Bragg's equation if the angle ψ of the crystal grain is equal to 0° (i.e. if the lattice planes of the crystal grain is parallel to the surface of the sample S). The task of adjusting the arrangement of the sample stage 113, X-ray generator 110 and X-ray detector 116 may be automatically performed by the device upon receiving a piece of information identifying the material of sample S entered by the operator through the input unit 102, or the operator may manually perform the adjustment.

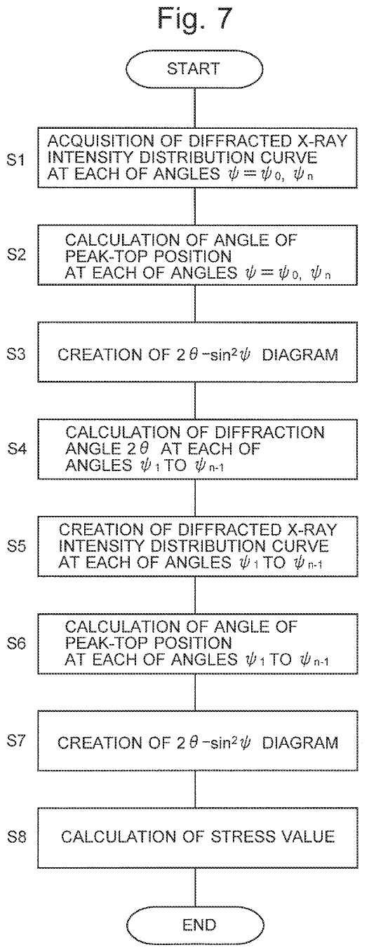

After the adjustment has been completed, the operator issues a command to initiate the stress measurement operation. Then, the control unit 100 performs the stress measurement operation according to the flowchart shown in FIG. 7.

Initially, the operation of creating a diffracted X-ray intensity distribution curve is performed under two conditions, i.e. with the X-ray generator 110 and the X-ray detector 116 located in the initial position shown in FIG. 5 as well as in a position rotated from the initial position by angle ψₙ (Step S1). In any of these two conditions, the sample stage 113 is held in the previously described position. Therefore, the angle formed by the surface of sample S and the incident X-ray beam is equal to θ when the X-ray generator 110 and the X-ray detector 116 are in the initial position, while the angle formed by the surface of sample S and the incident X-ray beam is equal to θ+ψₙ when the X-ray generator 110 and the X-ray detector 116 are in a position rotated from the initial position by angle ψₙ. In other words, the X-ray beam incident from the X-ray generator 110 satisfies the Bragg's equation for a crystal grain with angle ψ=0° among the crystal grains in a surface region of sample S in a stress-free state when the X-ray generator 110 and the X-ray detector 116 are in the initial position, while the X-ray beam incident from the X-ray generator 110 satisfies the Bragg's equation for a crystal grain with angle ψ=ψₙ among the crystal grains in the surface region of sample S when the X-ray generator 110 and the X-ray detector 116 are in a position rotated from the initial position by angle ψₙ.

Under any of those conditions, the X-ray beam incident on the surface of sample S is diffracted on the crystal grains present in the surface region of sample S, as shown in FIG. 6, and is subsequently introduced into the X-ray detector 116. The diffraction of X-rays occurs at each of the considerable number of crystal grains which are present within the area hit by the X-ray beam on the surface of sample S. The X-ray diffracted on each individual crystal grain falls onto an X-ray detecting element located at a position corresponding to the diffraction angle 2θ of the X-ray. The X-ray detector 116 generates a detection signal corresponding to the intensity of the X-ray received by each X-ray detecting element. The detection signals obtained with the considerable number of X-ray detecting elements show a relationship between the diffraction angle 2θ and the X-ray intensity. The data processing unit 120 receives those detection signals from the X-ray detecting elements through the amplifier 118. The data collector 121 collects those signals and creates a diffracted X-ray intensity distribution curve which shows the relationship between the diffraction angle 2θ and the X-ray intensity. The diffraction angle calculator 122 mathematically processes this distribution curve to determine the peak-top position at which the highest X-ray intensity occurs (Step S2). The peak-top positions at which the highest X-ray intensities at angles ψ=ψ₀(=0°) and ψ=ψₙ occur are designated as temporary diffraction angles 2θ_{ψ0} and 2θ_{ψn}, respectively.

In Steps S1 and S2, the arrangement of the X-ray generator 110 and the X-ray detector 116 is selected using the angle θ which satisfies the Bragg's equation for sample S in a stress-free state. Therefore, depending on the magnitude of the stress in sample S, the peak-top position of the diffracted X-ray intensity distribution curve will be displaced from the center of the measurement angular range of the X-ray detector 116, as shown by curve B in FIG. 4. Accordingly, in Step S2, the diffraction angle calculator 122 determines the peak-top position by performing a profile-fitting operation, rather than the subtracting and normalizing operations using the base line.

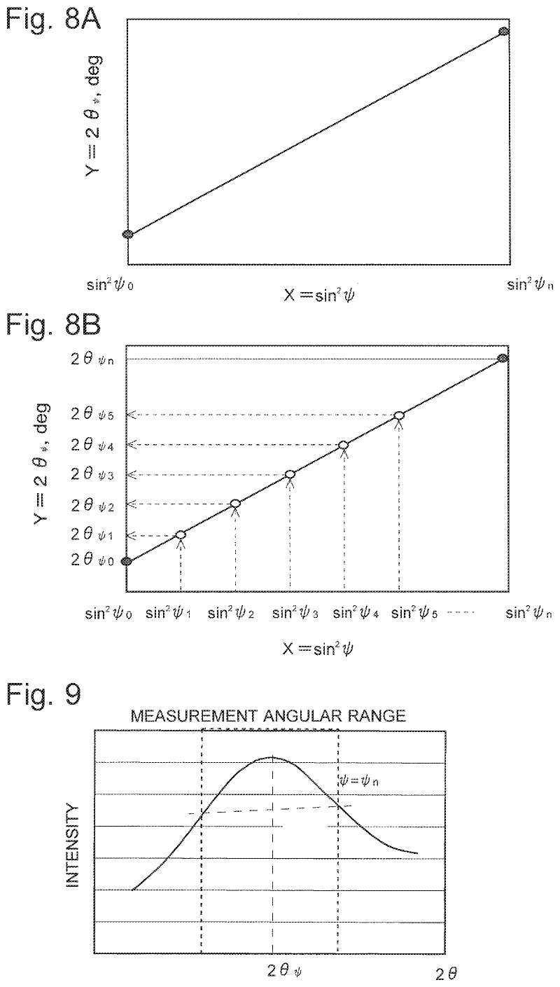

Furthermore, the diffraction angle calculator 122 creates a temporary 2θ-sin²ψ diagram using the determined diffraction angles 2θ_{ψ0} and 2θ_{ψn} as well as the angles ψ₀ and ψₙ which respectively correspond to those diffraction angles (Step S3). Based on this temporary 2θ-sin²ψ diagram, the diffraction angle calculator 122 calculates temporary diffraction angles 2θ_{ψ1} to 2θ_{ψn-1} at angles ψ₁ to ψₙ₋₁ between the angles ψ₀ and ψₙ (Step S4). FIG. 8A shows a temporary 2θ-sin²ψ diagram created from the diffraction angles 2θ_{ψ0} and 2θ_{ψn} as well as the angles ψ₀ and ψₙ. FIG. 8B shows temporary diffraction angles 2θ_{ψ1} to 2θ_{ψn-1} calculated from the temporary 2θ-sin²ψ diagram.

The operations described so far correspond to the contents of the operations of the first and second measurement sections of the present invention.

Subsequently, based on the temporary diffraction angles 2θ_{ψ1} to 2θ_{ψn-1} at angles ψ₁ to ψₙ₋₁ calculated in Step S4, the control unit 100 gradually changes the rotational position of the X-ray generator 110 and the X-ray detector 116 from the initial position shown in FIG. 5 by angles ψ₁ to ψₙ₋₁. At each of those positions, the control unit 100 performs the operation of creating a diffracted X-ray intensity distribution curve (Step S5). For this operation, the control unit 100 adjusts the arrangement of the X-ray generator 110 and the X-ray detector 116 by controlling the driving shafts so that the incident X-ray beam will form angle θ_{ψ1} to θ_{ψn-1} to the surface of sample S, while the diffracted X-ray exiting from the surface at angle θ_{ψ1} to θ_{ψn-1} will hit an X-ray detecting element located at the center of the X-ray detector 116. Under such an arrangement condition, the X-ray beam incident on sample S satisfies the Bragg's equation on crystal grains which are present in a surface region of sample S having the lattice planes oriented at angle ψ equal to ψ₁ to ψₙ₋₁, and the diffracted X-ray resulting from the incident X-ray beam hits an X-ray detecting element located roughly at the center of the X-ray detector 116. Subsequently, as described earlier, the detection signals of the X-ray detecting elements are sent from the X-ray detector 116 to the data processing unit 120, and a diffracted X-ray intensity distribution curve is created for each of the angles ψ₁ to ψₙ₋₁ based on those detection signals. FIG. 9 shows an example of the diffracted X-ray intensity distribution curve created in the present step. As shown in FIG. 9, the diffracted X-ray intensity distribution curve created in the present step has the peak-top position located roughly at the center of the measurement angular range of the X-ray detector 116. Accordingly, the true diffraction angle 2θ_{ψ1} to 2θ_{ψn-1} at angle ψ₁ to ψₙ₋₁ can be determined from this curve (Step S6).

Subsequently, the stress value calculator 123 creates a 2θ-sin²ψ diagram based on the angles ψ₁ to ψₙ₋₁ and the diffraction angles 2θ_{ψ1} to 2θ_{ψn-1} at those angles (Step S7). Then, the stress value calculator 123 determines a straight line (equation: Y=A+M*X) connecting the points on the 2θ-sin²ψ diagram, and calculates the stress value a from the gradient M by equation σ=K*M, where K is the stress constant (Step S8).

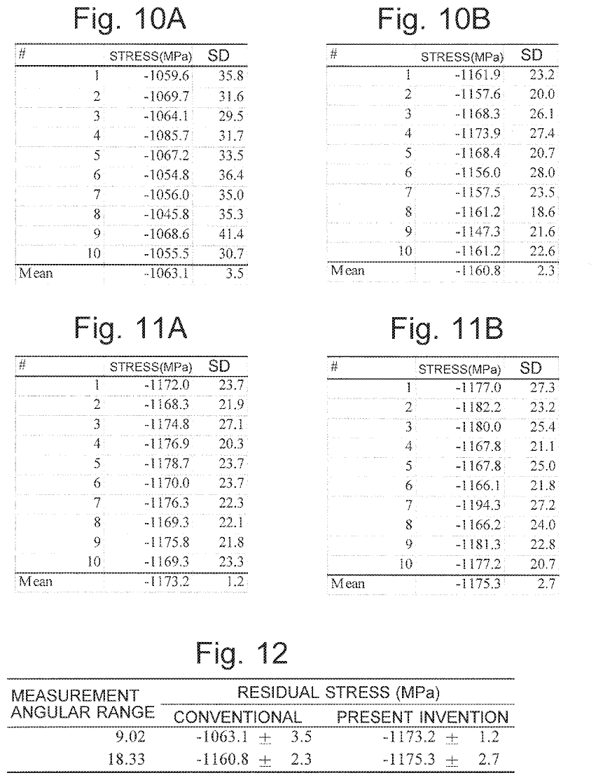

An experimental result of a measurement of the stress value of a specific sample using the previously described X-ray stress measurement device as well as a conventional device is hereinafter described with reference to FIGS. 10A, 10B, 11A, 11B and 12. A ferrous sample (high-stress iron-based specimen) whose peak had a half-value width of 4.5° to 5.2° was used as the sample. The measurement was performed at 10 rotational positions, i.e. n=10.

FIGS. 10A and 10B show stress values obtained by using the conventional device, while FIGS. 11A and 11B show stress values obtained by using the previously described X-ray stress measurement device. FIG. 12 is a table showing a summary of the stress values obtained with the conventional device and the previously described X-ray stress measurement device. An X-ray detector having a measurement angular range of 9.02°, and one having a measurement angular range of 18.33°, were used for the experiment. FIGS. 10A and 11A show the results obtained with the X-ray detector having a measurement angular range of 9.02°, while FIGS. 10B and 11B show the results obtained with the X-ray detector having a measurement angular range of 18.33°.

As is evident from FIGS. 10A and 10B, the stress values obtained with the conventional device significantly changed depending on the measurement angular range of the X-ray detector. By comparison, the stress values obtained with the X-ray stress measurement device according to the present embodiment were roughly the same and independent of the measurement angular range of the X-ray detector, as shown in FIGS. 11A and 11B. Those results confirm that a correct stress value can be obtained with the device according to the present embodiment even if the measurement angular range is considerably narrow.

### REFERENCE SIGNS LIST

10 . . . X-Ray Tube
110 . . . X-Ray Generator
11, 111 . . . Beam-Irradiating Slit
13 . . . Sample Holder
113 . . . Sample Stage
15 . . . Exit Slit
16, 116 . . . X-Ray Detector
17, 117 . . . Goniometer
100 . . . Control Unit
101 . . . Display Unit
102 . . . Input Unit
120 . . . Data Processing Unit
121 . . . Data Collector
122 . . . Diffraction Angle Calculator
123 . . . Stress Value Calculator
S . . . Sample

1. An X-ray stress measurement device configured to measure a stress in a sample made of a polycrystal by utilizing a diffraction phenomenon which occurs when an X-ray beam is irradiated onto the sample, the device comprising:
a sample-holding section;
an X-ray irradiating section configured to irradiate with an X-ray beam onto a sample held in the sample-holding section;
an X-ray detector section including a plurality of X-ray detecting elements one-dimensionally arrayed in a predetermined direction, the X-ray detector section configured to detect intensities of diffracted X-rays which are a radiation of X-rays diffracted from the sample within a predetermined angular range when the X-ray beam is irradiated from the X-ray irradiating section onto the sample;
a rotary drive section configured to individually rotate the X-ray irradiating section, the X-ray detector section and the sample-holding section so as to maintain a predetermined relationship between an angle formed by a surface of the sample held in the sample-holding section and the X-ray beam incident on the surface of the sample, and an angle formed by the surface of the sample and a diffracted X-ray travelling from the sample toward the X-ray detector section; and
a stress measurement section configured to rotate, for a measurement of a stress value of the sample, either the X-ray irradiating section and the X-ray detector section or the sample-holding section so as to change the angle formed by the surface of the sample held in the sample-holding section and the X-ray beam incident on the surface of the sample, while maintaining a positional relationship of the X-ray irradiating section and the X-ray detector section.

2. The X-ray stress measurement device according to claim 1, wherein the stress measurement section includes:
a first measurement section configured to arrange the sample-holding section, the X-ray irradiating section and the X-ray detector section so that the angle formed by the surface of the sample held in the sample-holding section and an incident X-ray beam which is a beam of X-rays incident on the sample becomes equal to θ₀ which satisfies the Bragg's equation, and so that an X-ray included in the radiation of X-rays from the sample and forming an angle of 2θ₀ with an extension of the incident X-ray beam hits an X-ray detecting element located at a center of the X-ray detector section when the sample is in a stress-free state, as well as to make the X-ray irradiating section irradiate with an X-ray beam onto the sample, and to determine a temporary diffraction angle 2θ_{ψ0} from detection values obtained for the X-ray beam by the plurality of X-ray detecting elements of the X-ray detector section;
a second measurement section configured to rotate either the X-ray irradiating section and the X-ray detector section or the sample-holding section, or both, so that the angle formed by the incident X-ray beam and the surface of the sample becomes equal to θ₀+ψₙ, while maintaining the positional relationship of the X-ray irradiating section and the X-ray detector section arranged by the first measurement section when determining the temporary, diffraction angle 2θ_{ψ0}, as well as to make the X-ray irradiating section irradiate with an X-ray beam onto the sample, and to determine a temporary diffraction angle 2θ_{ψn} from detection values obtained by the plurality of X-ray detecting elements of the X-ray detector section for the X-ray beam;
a diffraction angle calculator section configured to create a temporary 2θ-sin²ψ diagram from a combination of the temporary diffraction angle 2θ_{ψ0} and an angle of 0° as well as a combination of the temporary diffraction angle 2θ_{ψn} and an angle of θ₀+ψₙ, and to determine temporary diffraction angles 2θ_{ψ1} to 2θ_{ψn-1} at angles ψ₁ to ψₙ₋₁ within an angular range of 0° to 2θ_{ψn} in the temporary 2θ-sin²ψ diagram, respectively; and
a stress calculator section configured (1) to gradually rotate either the X-ray irradiating section and the X-ray detector section or the sample-holding section, or both, so that the angle formed by the incident X-ray beam and the surface of the sample becomes equal to each of the values from θ₀+ψ₁ to θ₀+ψₙ₋₁, while maintaining the positional relationship of the X-ray irradiating section and the X-ray detector section arranged by the first measurement section when determining the temporary diffraction angle 2θ_{ψ0}, and to make the X-ray irradiating section irradiate with an X-ray beam onto the sample, and to determine a peak-top position from detection values obtained by the plurality of X-ray detecting elements of the X-ray detector section for the X-ray beam, as well as (2) to create a true 2θ-sin²ψ diagram using the determined peak-top positions as true diffraction angles 2θ_{ψ1} to 2θ_{ψn-1} at angles ψ₁ to ψₙ₋₁, and to determine the stress value of the sample from the true 2θ-sin²ψ diagram.

3. The X-ray stress measurement device according to claim 2, wherein the stress calculator section is configured to create a graph with a vertical axis indicating the detection values of the plurality of X-ray detecting elements of the X-ray detector section and a horizontal axis indicating the diffraction angles of the diffracted X-rays respectively incident on the X-ray detecting elements, and to determine the peak-top position by performing a profile-fitting operation on the graph.

4. The X-ray stress measurement device according to claim 2, wherein the stress calculator section is configured to create a graph with a vertical axis indicating the detection values of the plurality of X-ray detecting elements of the X-ray detector section and a horizontal axis indicating the angles of the diffracted X-rays respectively incident on the X-ray detecting elements, and to determine the peak-top position by determining a base line in the graph and normalizing a waveform of the graph which remains after a subtracting operation for removing the base line from the graph is performed.
